(19) United States
(12) Patent Application Publication
(10) Pub. No.: US 2010/0233477 A1
(43) Pub. Date: Sep. 16, 2010

(54) FUNCTIONAL YARN AND METHOD FOR MANUFACTURING THE SAME

(76) Inventors: Yiu-Chuan HSIEH, Changhua City (TW); Yiu-Tien HSIEH, Changhua City (TW)

Correspondence Address: PATENTTM.US, P. O. BOX 82788, PORTLAND, OR, 97282-0788, US

(21) Appl. No.: 12/402,327

(22) Filed: Mar. 11, 2009

(51) Int. Cl. D02G 3/02; B29C 47/60

(52) U.S. Cl. 428/375; 264/211.22

(57) ABSTRACT

A functional yarn includes a thread, a plastic material coated on the thread and functional particles disposed evenly in the plastic material. A method for manufacturing a functional yarn includes the steps of blending a plastic material with function particles so that the functional particles are disposed evenly in the plastic material and coating the plastic material with functional particles on a thread in a hot-melt manner to form the functional yarn. Because the functional yarn uses the plastic material as a binding agent, the functional particles are adhered firmly on the thread.

### BACKGROUND OF THE INVENTION

1. Field of Invention

The present invention relates to a yarn, and more particularly to a functional yarn and method for manufacturing the same that adheres functional particles to a thread by using a plastic material.

2. Description of the Related Art

With economic development and life quality improvement, yarn used for clothes is not only required to provide comfortable feelings, but also to provide functional properties. A conventional functional yarn generally uses functional particles attached on the yarn to provide functional effects such as far infrared ray, magnetic field or antibiotic property.

With reference to FIG. 5, the conventional functional yarn is generally manufactured by mixing or soaking a thread (90) with functional particles (80) so the functional particles (80) are attached directly to the thread (90). However, because foregoing processes do not provide the functional particles (80) with enough binding strength, the functional particles (80) may fall off from the thread (90) after the conventional functional yarn is washed repeatedly or used for a period of time. Thus, functional effects of the conventional functional yarn may decrease gradually.

To overcome the shortcomings, the present invention provides a functional yarn and method of manufacturing the same to mitigate or obviate the aforementioned problems.

### SUMMARY OF THE INVENTION

The primary objective of the present invention is to provide a functional yarn and method for manufacturing the same that adheres functional particles to a thread by using a plastic material.

A functional yarn in accordance with the present invention comprises a thread, a plastic material coated on the thread and functional particles disposed evenly in the plastic material. A method for manufacturing a functional yarn in accordance with the present invention comprises the steps of blending a plastic material with function particles so that the functional particles are disposed evenly in the plastic material and coating the plastic material with functional particles on a thread in a hot-melt manner to form the functional yarn. Because the functional yarn uses the plastic material as a binding agent, the functional particles are adhered firmly on the thread.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side view of a functional yarn in accordance with the present invention;

FIG. 2 is a cross sectional side view of the functional yarn in FIG. 1 when a plastic material is coated on a thread;

FIG. 3 is a side view of an embodiment of a device for a method of manufacturing a functional yarn in accordance with the present invention;

FIG. 4 is a side view of another embodiment of a device for a method of manufacturing a functional yarn in accordance with the present invention; and

FIG. 5 is an enlarged perspective view of conventional yarn in accordance with the prior art.

### DETAILED DESCRIPTION OF THE INVENTION

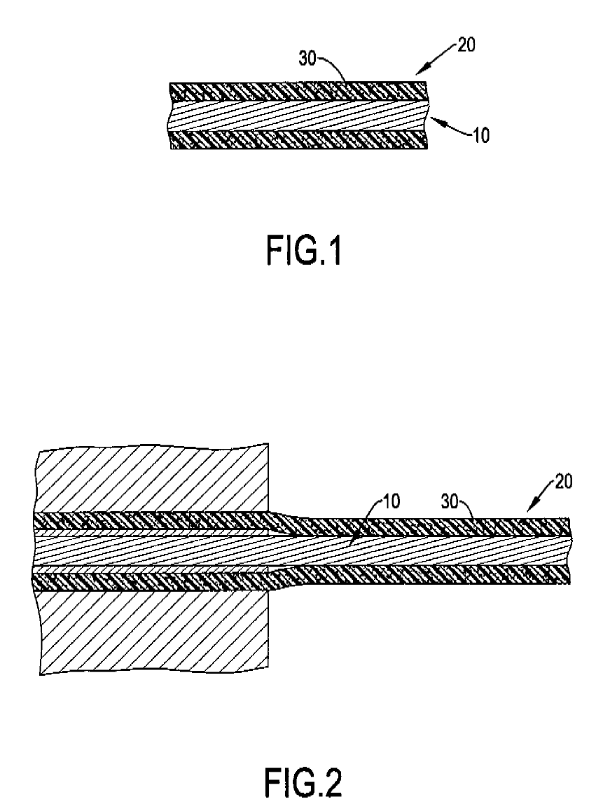

With reference to FIG. 1, a functional yarn in accordance with the present invention comprises a thread (10), a plastic material (20) and functional particles (30).

The thread (10) may be PVC (polyvinyl chloride), PET (polyester), PAN (polyacrylonitrile), PP (Propylene), PE (polyethylene) or Rayon and may have a liner density of 1 to 2000 denier.

The plastic material (20) is coated on the thread (10) and may have a thickness of 0.1 to 10 mm, The plastic material (20) may be PET (polyester), PU (polyurethane), PVC (poly (vinyl chloride)) or PP (polypropylene).

The functional particles (30) are disposed evenly in the plastic material (20) and may be 0.01 to 10 wt % of the functional yarn. The functional particles (30) may be carbonaceous particles or metal-containing particles or a mixture thereof. The carbonaceous particles may be bamboo charcoal particles. The metal-containing particles may be germanium, titanium, gold, silver, platinum, chromium, iron, cobalt, nickel, copper, zinc, calcium, barium, stannum or aluminum particles. The metal-containing particles may also be metallic oxide particles such as aluminum oxide, silicon dioxide, manganese dioxide, ferric oxide, ferroferric oxide or copper oxide particles. Thus, the functional particles (30) may provide properties of anti-electromagnetic wave and anti-static with conductive metal-containing particles. The functional particles (30) may also produce far infrared ray, magnetic field or long-term antibiotic effect that are helpful for human health.

Because the functional yarn uses the plastic material (20) as a binding agent for the functional particles (30), the functional particles (30) are adhered firmly on the thread (10). Thus, the functional particles are not easy to fall off from the thread (10) even though the functional yarn is washed repeatedly or used for a long time. Thus, the functional yarn provides long-term functional effects. The functional yarn can be woven with common yarn to form cloths. The cloths with the functional yarn can be used to manufacture clothes and perform close functional effects. The cloths with the functional yarn can also be used to manufacture accessories such as bags so as to increase values and functions of the accessories. When the plastic material (20) coated on the thread (10) has a large thickness (10 mm), the functional yarn can be used to manufacture imitating rattan furniture or serve as a filling material for a house to block electromagnetic wave.

With reference to FIG. 2, a method of manufacturing the functional yarn may comprise two steps. The first step is blending a plastic material (20) with function particles (30) so that the functional particles (30) are disposed evenly in the plastic material, The second step is coating the plastic material (20) with functional particles (30) on a thread (10) in a hot-melt manner to form the functional yarn.

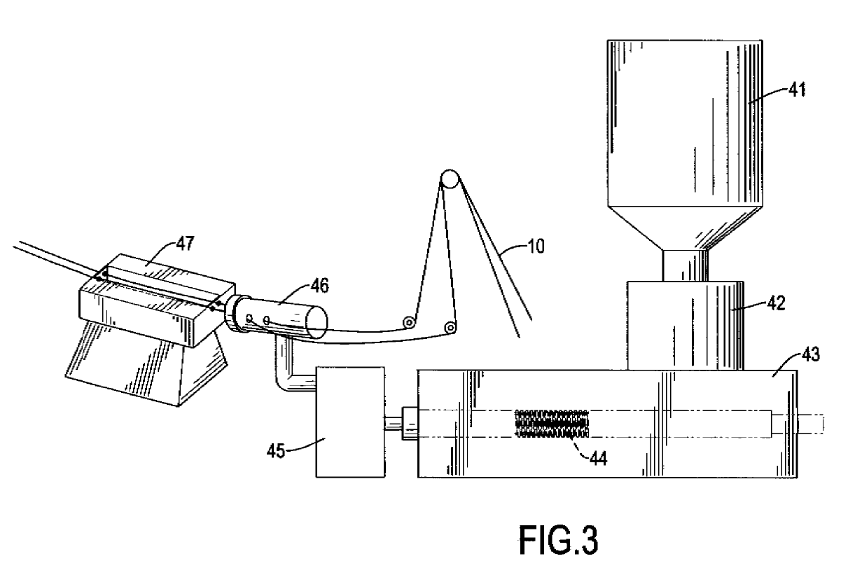

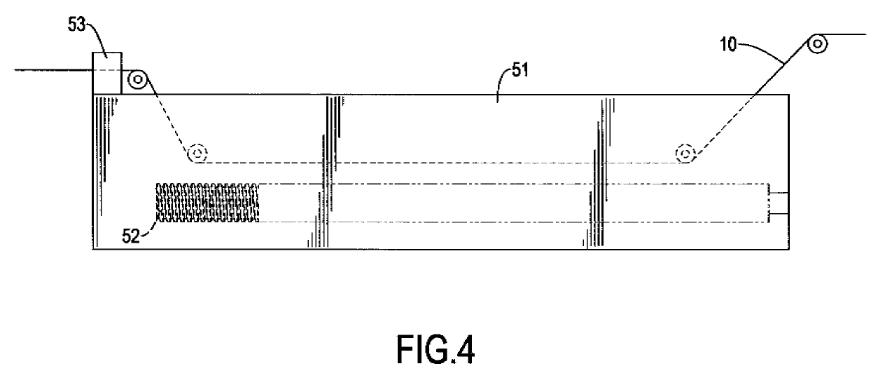

With further reference to FIG. 3, an embodiment of the method for manufacturing the functional yarn is a thread drawing method. The thread drawing method is described as following. Functional particles (30) and a plastic material (20) are added to a mixing tank (41) to be mixed and then delivered to a blending preparation device (42). After mixing, the functional particles (30) and the plastic material (20) are delivered to a hot-melt blending tank (43) having a feed screw (44). The functional particles (30) and the plastic material (20) are blended integrally by the feed screw (44) in the hot-melt blending tank (43) and then are delivered to a stationary blending device (45) to proceed further blending, After blending, the functional particles (30) and the plastic material (20) are delivered to a heating extrusion mold (46) and a thread (10) is drawn through the heating extrusion mold (46). When the thread (10) is drawn, the plastic material (20) with the functional particles (30) is extruded and coated on the thread (10). Then the thread (10) is soaked in a cold water tank (47) for cooling and shaping to form a functional yarn.

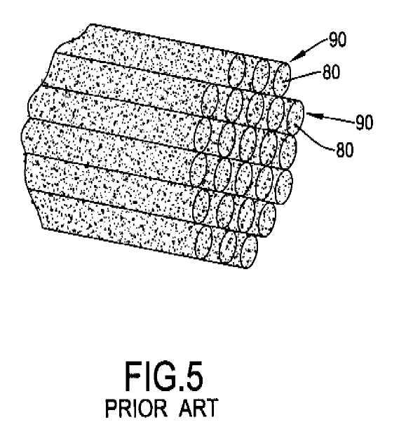

With further reference to FIG. 4, another embodiment of the method for manufacturing the functional yarn is a thread soaking method. The thread soaking method is described as following. Functional particles (30) and a plastic material (20) are added to a mass-produced tank (51) and are melt and blended integrally by a heater and a blending screw (52) in the mass-produced tank (51). Then a thread (10) is drawn through the mass-produced tank (51) and is soaking in the melt plastic material (20). Thus, the plastic material (20) with functional particles (30) is coated on the thread (10). After coating, the thread (10) is delivered to a scraper mold (53) to scrape superfluous plastic material (20) from the thread (10) to form a functional yarn.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A functional yarn comprising
a thread;
a plastic material being coated on the thread; and
functional particles being disposed evenly in the plastic material.

2. The functional yarn as claimed in claim 1, wherein the plastic material is PET (polyester), PU (polyurethane), PVC (poly (vinyl chloride)) or PP (polypropylene).

3. The functional yarn as claimed in claim 2, wherein the functional particles are carbonaceous particles.

4. The functional yarn as claimed in claim 2, wherein the functional particles are metal-containing particles.

5. The functional yarn as claimed in claim 2, wherein the functional particles are a mixture of carbonaceous particles and metal-containing particles.

6. The functional yarn as claimed in claim 3, wherein the carbonaceous particles are bamboo charcoal particles.

7. The functional yarn as claimed in claim 4, wherein the metal-containing particles are germanium, titanium, gold, silver, platinum, chromium, iron, cobalt, nickel, copper, zinc, calcium, barium, stannum or aluminum particles.

8. The functional yarn as claimed in claim 4, wherein the metal-containing particles are metallic oxide particles.

9. The functional yarn as claimed in claim 8, wherein the metallic oxide particles are aluminum oxide, silicon dioxide, manganese dioxide, ferric oxide, ferroferric oxide or copper oxide particles.

10. The functional yarn as claimed in claim 5, wherein the carbonaceous particles are bamboo charcoal particles.

11. A method for manufacturing a functional yarn comprising steps of
blending a plastic material with function particles so that the functional particles are disposed evenly in the plastic material; and
coating the plastic material with functional particles on a thread in a hot-melt manner to form the functional yarn.

12. The method for manufacturing a functional yarn as claimed in claim 11, wherein the functional particles and the plastic material are mixed before the step of blending.

13. The method for manufacturing a functional yarn as claimed in claim 12, wherein the functional particles and the plastic material are delivered to a hot-melt blending tank having a feed screw to be blended integrally by the feed screw in the hot-melt blending tank and then are delivered to a stationary blending device to proceed further blending in the step of blending.

14. The method for manufacturing a functional yarn as claimed in claim 13, wherein the functional particles and the plastic material are delivered to a heating extrusion mold and the thread is drawn through the heating extrusion mold to coat the functional particles and the plastic material on the thread in the step of coating.

15. The method for manufacturing a functional yarn as claimed in claim 14, wherein the thread is soaked in a cold water tank for cooling and shaping after the step of coating.

16. The method for manufacturing a functional yarn as claimed in claim 11, wherein the functional particles and the plastic material are delivered to a heating extrusion mold and a thread is drawn through the heating extrusion mold to coat the functional particles and the plastic material on the thread in the step of coating.

17. The method for manufacturing a functional yarn as claimed in claim 11, wherein the functional particles and the plastic material are added to a mass-produced tank and are melt and blended integrally by a heater and a blending screw in the mass-produced tank in the step of blending.

18. The method for manufacturing a functional yarn as claimed in claim 17, wherein the thread is drawn through the mass-produced tank and is soaking in the melt plastic material so the plastic material with functional particles is coated on the thread in the step of coating.

19. The method for manufacturing a functional yarn as claimed in claim 18, wherein the thread is delivered to a scraper mold to scrape superfluous plastic material from the thread after the step of coating.

20. The method for manufacturing a functional yarn as claimed in claim 11, wherein the thread is delivered to a scraper mold to scrape superfluous plastic material from the thread after the step of coating.
